(19) United States
(12) Patent Application Publication
(10) Pub. No.: US 2004/0007798 A1
(43) Pub. Date: Jan. 15, 2004

(54) Polymer blends for tip molding process and method of forming a plastic part

(76) Inventors: Andrew S. Kreager, Mason, OH (US); Stephen P. Andrzejewski, Middletown, OH (US); Philip T. Dodge, Cincinnati, OH (US); Barry T. Aubrey, Amelia, OH (US)

Correspondence Address: BROOKS KUSHMAN P.C., 1000 TOWN CENTER, TWENTY-SECOND FLOOR, SOUTHFIELD, MI, 48075, US

(21) Appl. No.: 10/405,458

(22) Filed: Apr. 2, 2003

Related U.S. Application Data
(60) Provisional application No. 60/376,648, filed on Apr. 30, 2002.

(51) Int. Cl. B29C 44/06; B29C 51/00

(52) U.S. Cl. 264/454; 428/402

(57) ABSTRACT

The present invention disclosed a skin resin suitable for forming plastic skin layers by tip molding processes. This skin resin comprises a plastic resin and an antioxidant. The disclosed resin is characterized as having an average particle size, bulk density, melt index, and pourability properties which make the resin particularly useful in tip molding. A foam resin suitable to be adhered to a skin layer is also disclosed. A method for forming plastic parts using the skin resin and foam resin of the present invention is provided.

### CROSS-REFERENCE TO RELATED APPLICATIONS

This application claims the benefit of U.S. Provisional Application Serial No. 60/376,648 filed Apr. 30, 2002.

### BACKGROUND OF THE INVENTION

1. Field of the Invention

This invention relates to plastic molding resins and methods of forming a reinforced multilayer plastic part from such resins. More specifically, the present invention relates to resins capable of being used in a tip molding process and to methods of making parts by such a tip molding process.

2. Background Art

Plastic molding processes are widely used in the automotive industry to produce such diverse plastic parts as truck beds, instrument panels, console boxes, door trims, and interior trim. Although numerous methods exist for molding plastic parts, the ever increasing structural demands on such plastic parts necessitates the development of new and improved molding processes. One solution for better performance from plastic parts is a foam sandwich construction which consists of a plastic foam layer disposed between two plastic skin layers (“sandwich construction”). This sandwich construction is capable of replacing steel assemblies and fiberglass lay-ups in boat, RV, and automotive applications. Furthermore, with the appropriate material selection and layer structure the strength to weight ratio is better than fiberglass lay-ups and steel. However, the latter improvement is only true at temperatures below 150° F. At higher temperatures, the sandwich composite softens causing creep (deflection under load over long period of time) and becomes a problem even at low stress levels. In addition, CLTE (coefficient of linear expansion) is higher for a sandwich composite than either steel or fiberglass. This difference in CLTE creates fit and finish problems when a simple polyolefin based sandwich construction is used.

One solution to the problems associated with the sandwich construction is to incorporate reinforcements such as welded wire mesh, fiberglass mats, and other structural components. It is know that such reinforcements improve both high temperature creep and CLTE. Furthermore, ribbed kiss-offs and conical kiss-offs are known to improve stability and increase the useful temperature range of sandwich constructions. Several plastics molding techniques are capable of forming reinforced sandwich constructions.

Powder tip molding (“tip molding”) is an emerging plastic molding technology which is capable of meeting many of these structural requirements through the production of reinforced plastic parts. In the tip molding process, open face mold halves are filled with powder and heated to form a plastic skin layer. Reinforcements are added along with a preformed foam middle layer. The mold halves are then clamped together and then heated to form a three layer foam sandwich composite. The use of a preformed middle layer presents a number of technical difficulties. For example, the use of preformed layers makes is difficult to completely fill corners and to fabricate parts with thin cross-sections. The advantage of an improved tip molding process as disclosed in the present invention is readily apparent by examining the more common molding technologies.

Rotational molding (“rotomolding”) is perhaps the closest technology to tip molding. Roto-molding has been a commercial process for years. In rotomolding a polymer powder is placed in an enclosed mold and heated until the plastic is molten. The mold is then rotated such that all the mold surfaces are coated with plastic. The rotation of the mold allows the fabrication of a hollow part will uniform wall thickness. Rotomolding has successful produced parts as large as 11 feet by 7 feet with a weight of at least 250 lbs. Parts much larger than this are difficult to make by rotomolding because of the prerequisite large mold thickness that would be necessary to ensure dimensional stability. Furthermore, roto molding is capable of producing hollow part with a sandwiched construction. In such a sandwich construction, a plastic foam layer is interposed between two plastic skin layers. However, rotomolding is limited by the types of reinforcements which can be incorporated into a plastic part. Reinforcements must be blended with the plastic powder before it is dropped into the mold. Accordingly, it is not possible to incorporate such structures as fiberglass matts. Furthermore, it is difficult to mold very thin parts by rotomolding.

Injection molding is capable of producing parts with a reinforced foam sandwich construction. In injection molding plastic resin is heated to the point where is will flow under pressure. The plastic is then injected into a mold. A three layer sandwich part can be made by forming the two skin layers by injection mold and then subsequently welding the skins together. The resultant hollow core is then filled with a foamed to form the three layer sandwich part. Although injection molding may produce an excellent three layered part, the high cost of equipment and tooling precludes high volume production of such parts.

Alternatively, three layer structures may be made by twin sheet thermo forming in which two plastic sheets are forced against each other under heat and pressure to form a double-walled part with a central cavity. The middle foam layer is added as a secondary step. Reinforcements such as wire mesh, fiberglass mat and structural inserts are easily incorporated. The sheet stock can be made with a percentage of long glass fibers eliminating the need for other reinforcements. A drawback of twin sheet forming is that the process is slow and requires large amounts of space and extra labor. Furthermore, large parts are not easily made by twin sheet forming. Finally, some sections of parts made by twin sheet forming are made thicker because it is not possible to get a truly uniform sidewall distribution of the skin layers. Accordingly, parts are heavier than those with perfectly uniform skin thicknesses.

Three layer structures made by compression molding are made from skins in the form of molten “blobs” which are bonded to reinforcements and a preformed core (not foam) via heat and pressure. The process is limited because foam cores tent to collapse before bonding pressure is achieved. Shapes are typically limited to very simple flat sections unless more complicated multi-piece assemblies are used.

Blow-molding is another technology that is used to form hollow plastic parts. In the typical blow-molding process, plastic is introduced between two mold halves and forced outward by pressurized air to form a part having the shape of the mold. Coextrusion equipment is readily available for blow-molding operation that will allow the converter to make flat panels with kiss-offs and a long glass fiber reinforced layer. Structural reinforcements are readily incorporated into parts with blow-molding and the parts can be foamed in a secondary step. Furthermore, parts made by blow-molding have reasonable stiffness and dimensional stability. However, there are significant limitations to the blow-molding process. The equipment and tooling required is very expensive necessitating an initial capital investment that can only be justified for very high volume jobs that are slated to run for many years. Furthermore, the lead-time for equipment is substantial and the process is limited to practically relatively small parts. Specifically, parts that weigh less than 100 lbs. and that are not more than 3 feet×6 feet long. Finally, the top and bottom skins of sandwich type parts must necessarily have the same structure.

For the reasons set forth above, there exists a need for an improved molding process for forming reinforced three layered plastic parts this is relatively inexpensive and capable of forming large parts.

### SUMMARY OF THE INVENTION

In an embodiment of the present invention, a plastic resin moldable into the outer skin layers of a sandwich construction is provided (herein referred to as a “skin resin.”) As used herein skin resin means a resin useful for forming the outer skin layers of a sandwich composition that has a middle foam layer sandwiched between two outer non-foam skin plastic layers. The skin resin of the present invention comprises a plastic resin and an antioxidant. The skin resin optionally includes one or more additives. Suitable additives include, but are not limited to UV stabilizers, flame retardants, fillers, and pigments. The skin resin of the present invention is further defined by several properties which make the skin resin useable in the tip molding process. These properties include the average particle diameter, bulk density, and the melt index.

In another embodiment of the present invention, a plastic resin moldable in the middle foam layer of a sandwich construction is provided (herein referred to as a “foam resin.”) The foam resin of the present invention comprises a plastic resin and an antioxidant. The foam resin of the present invention is also further defined by several properties which make the skin resin useable in the tip molding process. These properties include the average particle diameter, bulk density, and the melt index.

In still another embodiment of the present invention, a method for forming a plastic part with a sandwich construction. Such a part optionally includes one or more reinforcements such as glass fibers, fiberglass mats, wire mesh, tubes, and other similar structural components. The method utilizes the skin resin of the present invention to form the two skin layers of a sandwich construction. Each skin layer is formed by a tip molding process on separate mold halves. The mold halve coated with the skin layers are then clamped together with the foam resin of the present invention placed in between. The foam resin is then heat activated thereby inducing the formation of the foam middle layer of the sandwich construction. The resulting sandwich structure is accordingly superior to analogous structures formed by the other molding processes. Such sandwich structures have superior adhesion between the skin layers and the middle foam layer compared to tip molding processes that utilize a foam middle layer preform. Furthermore, reinforcements are more easily incorporated into the sandwich structure of the present invention. Finally, the present invention offers a significant advantage over equipment intensive process such as blow molding in that the equipment and molds are less expensive and easier to fabricate.

In yet another embodiment of the present invention, a plastic part with a sandwich construction made by a tip molding process is provided. The plastic part is made by the method described above. Accordingly, the plastic part of the present invention has superior properties with respect to adhesion between the skin layers and the foam layer, ease of incorporating reinforcements, filling mold corners, and equipment expense.

### BRIEF DESCRIPTION OF THE DRAWINGS

FIG. 1 is a cross-section through a three layer plastic part with wire reinforcements made with the resins of the present invention.

FIG. 2 is a cross-section through a three layer plastic part with wire, tubular, and fiber matting reinforcements made with the resins of the present invention.

FIG. 3 if flow chart describing the method of making a three layer plastic part of the present invention.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

The present invention provides an improved plastic skin resin powder capable of forming skin layers in a tip molding process. The skin resin of the present invention comprises a plastic resin and an antioxidant. Suitable plastic resins include polyolefin-based resins, polystyrene-based resins, and polycabonates. The preferred plastic resins are polyolefin-based resins such as high density polyethylene, low density polyethylene, linear low density polyethylene, polypropylene, polyisopropylene, polyisobutylene, polybutadiene, and the like. Further examples of polyolefin-based resins include homopolymers and copolymers synthesized from one or more of olefin monomers such as ethylene, propylene and butylene. The specific type of plastic resin used is determined by the end use requirements of such parameters as stiffness, creep, impact resistance, CLTE, and etc.

The skin resin of the present invention includes an antioxidant preferably in an amount of about 450 ppm to about 1750 ppm. More preferably, the antioxidants are present in an amount of about 500 ppm to about 1000 ppm, and most preferably, the antioxidants are present in an amount of about 750 ppm. Suitable antioxidants include the phenol, phosphite, and thiol types of antioxidants. Preferably, the antioxidant is a blend of a phenolic antioxidant and a phosphite antioxidant. Examples of these antioxidants include Cyanox 2777 (a blend of a phenolic antioxidant and a phosphite antioxidant commercially available from Cytec Industries, West Paterson, N.J.) or a blend of Irganox 3114 (tris-(3,5-di-tert-butyl-4-hydroxybenzyl) isocyanurate commercially available from Ciba Speciality Chemicals) and a phosphite antioxidant such as Irgafos 168, Irgafos 12, or Ultranox 626. The antioxidant is important in improving stability and reducing yellowing. Furthermore, the antioxidants provide for the widest processing windows.

The skin resin of the present invention optionally includes one or more additives. Suitable additives include, but are not limited to UV stabilizers, flame retardants, fillers, and pigments. Additives are important in establishing the long term stability of the skin resin as well as chemical and impact resistance. Specifically, the skin resin of the present invention optionally includes UV stabilizers present in an amount from about 1500 ppm to about 2500 ppm. More preferably the UV stabilizers are present in an amount of 1750 ppm to about 2250 ppm, and most preferably, the UV stabilizers are present in an amount of about 2000 ppm. Suitable UV stabilizers include, but are not limited to hindered amine light stabilizers (“HALS”). Examples of HALS include: Chimassorb 944, Chimassorb 994, Chimassorb 905, Tinuvin 770, Tinuvin 992, Tinuvin 622, Tinuvin 144, and Spinuvex A36 available from Geigy; and Cyasorb UV 3346 and Cyasorb UV 944 commercially available American Cyanamide. Particularly preferred UV stabilizers are Cytec UV 3346 and Chemasorb 944 (poly[N,N-bis(2,2,6,6-tetramethyl-4-piperidinyl)-1,6-hexanediamine-co-2,4-dichloro-6-morpholino-1,3,5-triazine.)

The skin resin of the present invention still further optionally includes a flame retardant. Flame retardants include, for example, halogen-containing compounds, antimony oxides, or phosphorus compounds. Suitable flame retardants include, but are not limited to aluminum trihydrate, antimony oxide (Sb₂O₃), and decabromobiphenyl oxide (“decabrome”).

Finally, the skin resin of the present invention includes fillers such as long glass fibers, carbon fiber, and talc. These fillers allow the material properties of the skin resin to be adjusted. Preferably, these fillers are present in an amount of about 5% to 30% of the weight of the skin resin.

The skin resin is made by melt blending in which the plastic resin, the antioxidant, and optionally one or more other additives are mixed together and then extruded into pellets. Color pigments if desired are added in and melt blended to form pigmented pellets. The pellets are then ground and processed by methods known to those skilled in the art into a powder. Alternatively, the skin resin is made by mixing the plastic resin, the antioxidant, and optionally one or more other additives including color pigments and then processed by method know to those in the art into pellets. Accordingly, the skin resin is characterized by the average particle diameter of the powder into which the skin resin is processed. The average particle diameter is preferably from about 95 microns to about 1300 microns. More preferably the average particle diameter is from about 400 microns to about 600 microns, and most preferably about 500 microns. The skin resin of the present invention is further characterized by having a bulk density of about 15 to 60 g/100 cc, more preferably the bulk density is from 20 to 40 g/100 cc, and most preferably about 30 g/100 cc. The resin of the present invention is also characterized by its pourability. Pourability is evaluated by measuring the time in seconds that is takes for a 100 g sample of a powder to completely flow through an aluminum funnel (30° cone 0.380″ diameter opening). Preferably the skin resin powder of the present invention has a pourablity of about 5 to 50 seconds, more preferably the pourabilty is from about 10 to 40 seconds, and most preferably the pourability is about 28 seconds. The skin resin is still further characterized as having a melt index of 0.5 to 10 grams per 10 minutes, more preferably the melt index is 2 to 8 grams per minutes. The parameters for the particle size, pourability, and bulk density are important in providing the flow characteristics necessary to evenly distribute the skin layer and give a homogenous cross-section. The melt index is also important in determining flow properties and in particular determines the ability of the skin resin to cover corners.

In another embodiment of the present invention an improved plastic foam resin capable of forming a foamed layer in a tip molding process is provided. The foam resin of the present invention comprises a plastic resin and a blowing agent. Suitable plastic resins include polyolefin-based resins, polystyrene-based resins, and polycabonates. The preferred plastic resins are polyolefin-based resins such as high density polyethylene, low density polyethylene, linear low density polyethylene, polypropylene, polyisopropylene, polyisobutylene, polybutadiene, and the like. Further examples of polyolefin-based resins include homopolymers and copolymers synthesized from one or more of olefin monomers such as ethylene, propylene and butylene. The specific type of plastic resin used is determined by the end use requirements of such parameters as stiffness, impact, CLTE, and etc.

The foam resin of the present invention includes a blowing agent in an amount of 1% to 12% of the total weight of the foam resin. Preferably, the blowing agent will have a particle size from about 0.5 to 30 microns. Blowing agents in this size range efficiently wet out on the surface of the plastic resin powder. A preferred blowing agent is azodicarbonimide. The activation temperature of the foam resin may be modified by the incorporation of additives in the blowing agent. For example, zinc oxide in an amount of about 0.1% to 0.75% of the weight of the blowing agent may be added to adjust the activation temperature. The foam resin is still further characterized as having a melt index of 0.5 to 10 grams per 10 minutes. For tip molding parts with a thin cross-section, the melt index is preferably from 5.0 to 20 grams per 10 minutes.

The foam resin is preferably made by grinding to the specifications below and then dry blending with the blowing agent. Accordingly, the foam resin is characterized by the particle diameter of the powder into which the foam resin is processed. The particle diameter is preferably from about 95 microns to about 1300 microns. The foam resin of the present invention is further characterized by having a bulk density of about 15-60 g/100 cc, more preferably the bulk density is from 20 to 40 g/100 cc, and most preferably about 30 g/100 cc. The resin of the present invention is also characterized by its pourability. Pourability is evaluated by measuring the time in seconds that is takes for a 100 g sample of a powder to completely flow through an aluminum funnel (30° cone 0.380″ diameter opening). Preferably the skin resin powder of the present invention has a pourablity of about 5 to 50 seconds, more preferably the pourabilty is from about 10 to 40 seconds, and most preferably the pourability is about 28 seconds. The skin resin is still further characterized as having a melt index of 0.5 to 10 grams per 10 minutes. For applications in which part with thin cross-sections, the melt index is preferably from 5.0 to 20 g/10 min. The parameters for the particle size, pourability, melt index, and bulk density are important in providing the flow characteristics necessary to evenly distribute the foam layer, adhere to reinforcements, and give a homogenous cross-section particularly for thin cross-sections.

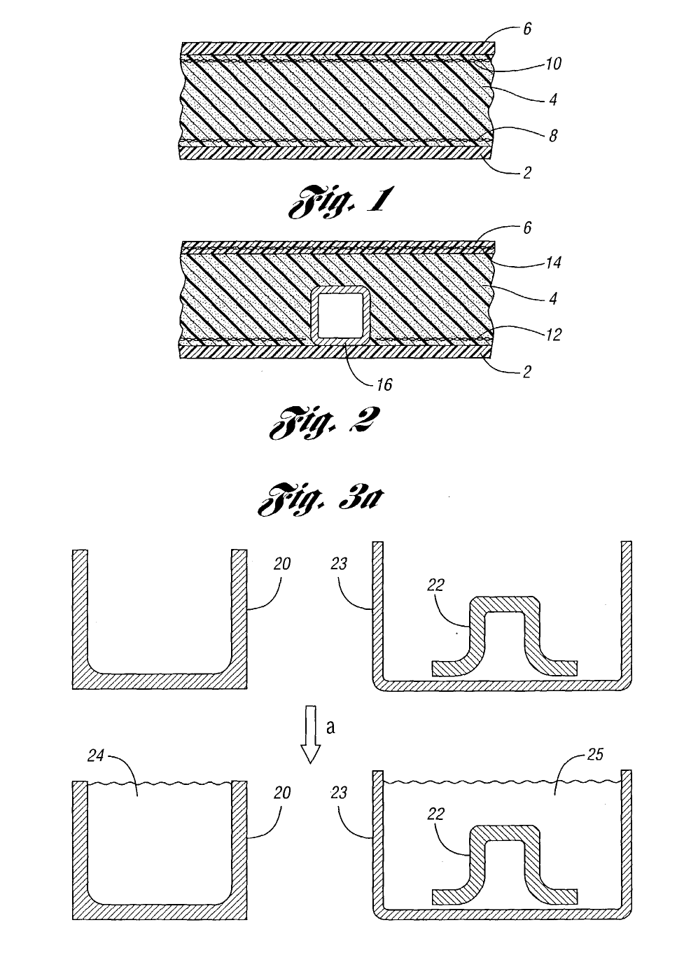

With reference to FIG. 1, a cross-section of a plastic part made with the skin resin and foam resin of the present invention is provided. First skin layer 2 is disposed over middle foam layer 4. Preferably, the middle foam layer will completely cover first skin layer 2. However, if desired, regions of first skin layer 2 may be uncoated by middle foam layer 4. Similarly, second skin layer 6 is disposed over middle foam layer 4. Skin layer 6 need not be the same plastic skin resin as skin layer 2. Wire screen 8 is embedded in middle foam layer 4 near the interface to skin layer 2 and wire screen 10 is embedded in foam layer 4 near the interface to skin layer 6. Skin layers 2, 6 are made by the tip molding process utilizing the skin resin of the present invention, while middle foam layer 4 is made by the tip molding process utilizing the foam resin of the present invention.

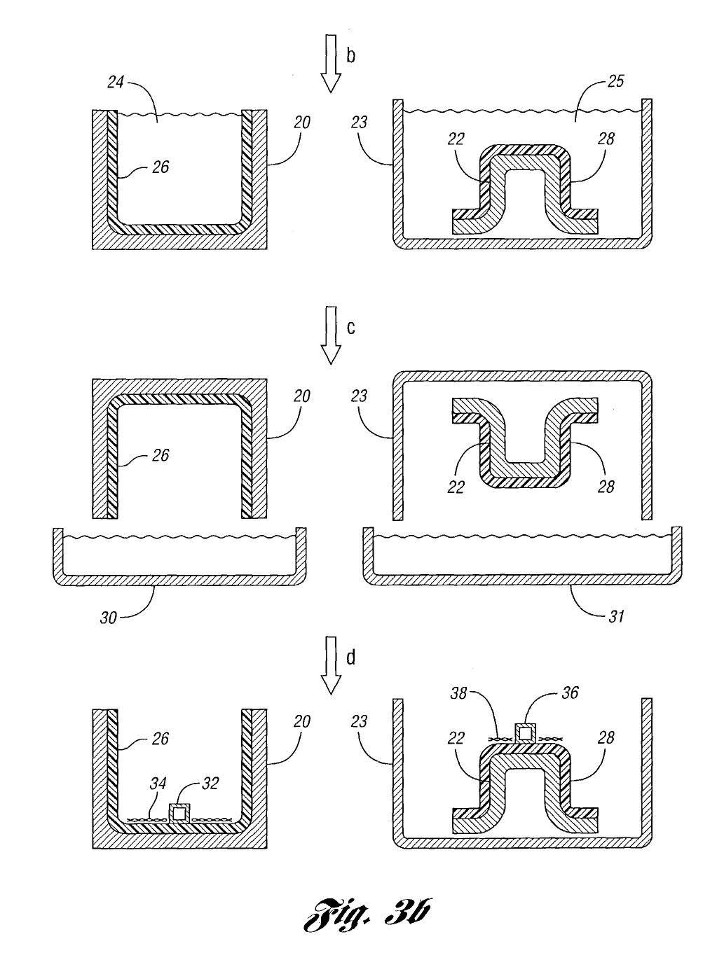

With reference to FIG. 2, a cross-section of a reinforced plastic part of the present invention is provided. First skin layer 2 is disposed over middle foam layer 4. Similarly, second skin layer 6 is disposed over middle foam layer 4. Fiber matting 12 is embedded in middle foam layer 4 near the interface to skin layer 2 and wire screen 14 is embedded in skin layer 6. Tubular reinforcement 16 is embedded in foam layer 4 near the interface with skin layer 2.

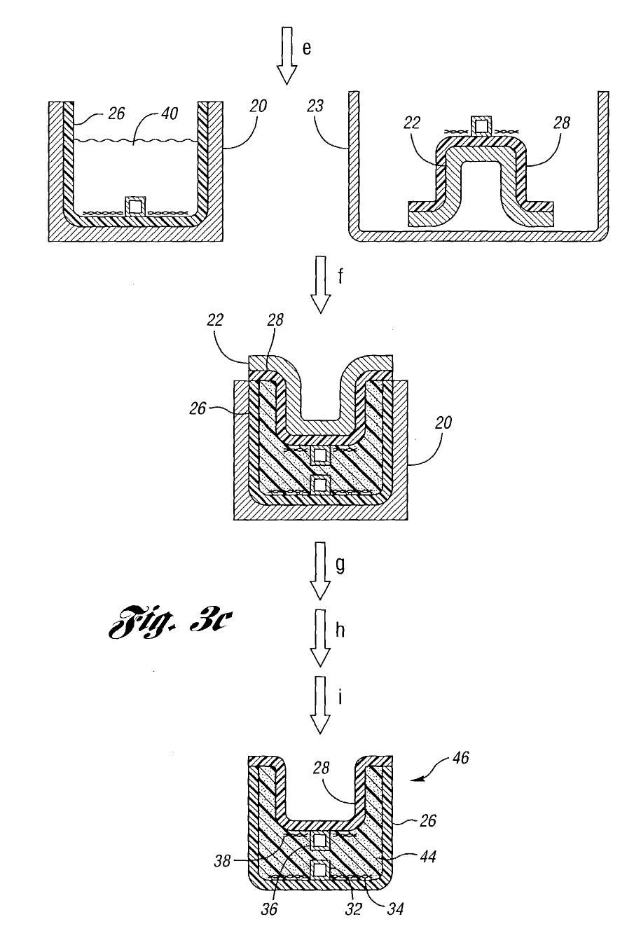

In yet another embodiment of the present invention, a method utilizing the skin and foam resins of the present invention to mold a plastic part is provided. With reference to FIG. 3, the method comprises the following steps:

a) charging first mold half 20 with skin resin 24 and second mold half 22 in container 23 with skin resin 25, wherein first mold half 20 and second mold half 22 are at a sufficient temperature to melt skin resins 24, 25. Skin resins 24, 25 are the skin resin of the present invention described above. Furthermore, skin resins 24, 25 need not have the same composition. Optionally, a thin skin layer (not show) of a different composition can be sprayed on the mold surface prior to charging with the skin resin;

b) allowing first skin layer 26 to form on first mold half 20 and second skin layer 28 to form on second mold half 22. The precise thickness of the skin layers will depend on time and temperature;

c) inverting first mold half 20 and second mold half 22 to pour out any excess skin resins 24, 25. This operation leaves skin layers 26, 28 attached to mold halves 20, 22. Excess skin resins 24, 25 are collected in catch pans 30, 31. Excess skin resins 24, 25 may be reused;

d) optionally adding reinforcements 32, 34 to first skin layer 26 and reinforcements 36, 38 to second skin layer 28;

e) charging first mold half 26 coated and second mold half 22 coated with foam resin 40. Optionally, only one mold half may be charged;

f) clamping first mold half 20 to second mold half 22;

g) heating first mold half 20 and second mold half 22 at a sufficient temperature to activate foam resin 40. Typically, this temperature will be approximately 200° C.;

h) allowing foam layer 44 to form, wherein foam layer 44 is adhered to skin layer 26 and to skin layer 28;

i) cooling first mold half 20 and second mold half 22; and

j) removing formed part 46 from first mold half 20 and second mold half 22.

In yet another embodiment of the present invention, an improved plastic part made by the method described above is provided. This plastic part will has superior adhesion between the plastic layers, superior dimensional stability, and will be capable of being formed in very thin cross-section. Accordingly, the present invention provide a molded plastic part made by the step comprising:

a) charging a first mold half and a second mold half with a skin resin, wherein the first mold half and the second mold half are at a sufficient temperature to melt the skin resin;

b) allowing a first skin layer to form on the first mold half and a second skin layer to form on the second mold half;

c) inverting the first mold half and the second mold half such that excess skin resin is poured out;

d) optionally adding one or more reinforcements to the first skin layer and to the second skin layer. Optionally, steps a through d may be repeated several times with the same of different skin resin to produce a multilayered structure;

e) charging the mold half and the second mold half with a foam resin;

f) clamping the first mold half and the second mold half together;

g) heating the first mold half and the second mold half to a sufficient temperature to activate the foam resin;

h) allowing a foam layer to form, wherein the foam layer is adhered to the first skin layer and the second skin layer;

i) cooling the first mold half and the second mold half; and

j) removing the plastic part from the first mold half and the second mold half.

The following examples illustrate the various embodiments of the present invention. Those skilled in the art will recognize many variations that are within the spirit of the present invention and scope of the claims.

### EXAMPLE 1

Approximately 25000 lbs of a skin resin is made by combining about 25000 lbs of high density polyethylene (HDPD), 18.75 lbs of Cyanox 2777, and about 50 lbs of Chimassorb 944. The resulting resin is processed to produce a resin with a 0.952 density and a melt index of 6. A foam resin is made by combining about 25000 lbs HDPD and about 500 lbs Azo D200. About a 66 lb portion of the skin resin is introduced to two mold halves. The mold halves are in the form of a truck bed. The molds are heated to about 550° F. thereby forming a skin layer. The unmelted skin resin is then poured out. About 33 lbs of the foam resin is added to the female shaped mold half. The two mold halves are then clamped together and heated to about 550° F. The molds are then cooled and then opened to remove the truck bed.

### EXAMPLE 2

Approximately 1000 lbs of a skin resin is made by combining about 1000 lbs of high density polyethylene (HDPD), 0.75 lbs of Cyanox 2777, and about 7 lbs of Chimassorb 944. The resulting resin is processed to produce a resin with a 0.962 density and a melt index of 6. A foam resin is made by combining about 1000 lbs HDPD and about 20 lbs Azo D200. About 20 lbs of the skin resin is introduced to two mold halves. The mold halves are in the form of a table top. The molds are heated to about 550° F. thereby forming a skin layer. The unmelted skin resin is then poured out. About 17 lbs of the foam resin is added to the female shaped mold half. The two mold halves are then clamped together and heated to about 550° F. The molds are then cooled and then opened to remove the table top.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A skin resin useful for forming a plastic skin layer by a tip molding process, the skin resin comprising:
a plastic resin; and
an antioxidant, wherein the skin resin is ground into a powder having an average particle diameter from about 95 microns to about 1300 microns, a bulk density of about 15 to 60 g/100 cc, and a melt index of about 0.5 to about 10 grams per 10 minutes.

2. The skin resin of claim 1 wherein the average particle diameter is from about 400 microns to about 600 microns;
the bulk density is from about 20 to about 40 g/100 cc; and
the melt index is from about 2 to 8 grams per 10 minutes.

3. The skin resin of claim 1 wherein the plastic resin is a polyolefin-based resin, a polystyrene-based resin, a polycarbonate resin, or mixture thereof.

4. The skin resin of claim 1 wherein the plastic resin is polyethylene or polypropylene (homopolymers and copolymers).

5. The skin resin powder of claim 1 wherein the antioxidant is a phenol type antioxidant, phosphite type antioxidant, thiol type antioxidant, or mixtures thereof present in an amount of about 450 ppm to about 1750 ppm.

6. The skin resin powder of claim 1 further comprising an UV stabilizer present in an amount of about 1500 ppm to about 2500 ppm.

7. The skin resin powder of claim 1 further comprising a flame retardant, a filler, a pigment additive, or mixture thereof.

8. A foam resin useful for forming a plastic foam layer bonded to a skin layer, the foam resin comprising:
a plastic resin; and
a blowing agent present in an amount of about 1% to 12% of the total weight of the foam resin, wherein the skin resin wherein the skin resin is ground into a powder having an average particle diameter from about 95 microns to about 1300 microns, a bulk density of about 15 to 60 g/100 cc, and a melt index of about 0.5 to about 20 grams per 10 minutes.

9. The foam resin of claim 8 wherein the average particle diameter is from about 400 microns to about 600 microns;
the bulk density is from about 20 to about 40 g/100 cc; and
the melt index is from about 0.5 to about 10 grams per 10 minutes.

10. The foam resin of claim 8 wherein the plastic resin is a polyolefin-based resin, a polystyrene-based resin, a polycarbonate resin, or mixture thereof.

11. The foam resin of claim 8 wherein the plastic resin is polyethylene or polypropylene.

12. The foam resin of claim 8 wherein the blowing agent is azodicarbonimide.

13. A method for making a plastic part, the method comprising:
a) charging a first mold half and a second mold half with a skin resin, wherein the first mold half and the second mold half are at a sufficient temperature to melt the skin resin;
b) allowing a first skin layer to form on the first mold half and a second skin layer to form on the second mold half;
c) inverting the first mold half and the second mold half such that excess skin resin is poured out;
d) optionally adding one or more reinforcements to the first skin layer and to the second skin layer;
e) charging the mold half and the second mold half with a foam resin;
f) clamping the first mold half and the second mold half together;
g) heating the first mold half and the second mold half to a sufficient temperature to activate the foam resin;
h) allowing a foam layer to form, wherein the foam layer is adhered to the first skin layer and to the second skin layer;
i) cooling the first mold half and the second mold half; and
j) removing the plastic part from the first mold half and the second mold half.

14. The method of claim 13 wherein the skin resin comprises:
a plastic resin; and
an antioxidant, wherein the skin resin is ground into a powder having an average particle diameter from about 95 microns to about 1300 microns, a bulk density of about 15 to 60 g/100 cc, and a melt index of about 0.5 to about 10 grams per 10 minutes.

15. The method of claim 14 wherein the average particle diameter is from about 400 microns to about 600 microns;
the bulk density is from about 20 to about 40 g/100 cc; and
the melt index is from about 2 to 8 grams per 10 minutes.

16. The method of claim 14 wherein the plastic resin is a polyolefin-based resin, a polystyrene-based resin, a polycarbonate resin, or mixture thereof.

17. The method of claim 14 wherein the plastic resin is polyethylene or polypropylene.

18. The method of claim 14 wherein the antioxidant is a phenol type antioxidant, phosphite type antioxidant, and thiol type antioxidant present in an amount of about 450 ppm to about 1750 ppm.

19. The method of claim 14 wherein the skin resin further comprises a UV stabilizer.

20. The method of claim 14 wherein the skin resin further comprises a flame retardant, a filler, a pigment additive, or mixtures thereof.

21. The method of claim 14 wherein the foam resin comprises:
a plastic resin; and
a blowing agent present in an amount of about 1% to 12% of the total weight of the foam resin, wherein the skin resin wherein the skin resin is ground into a powder having an average particle diameter from about 95 microns to about 1300 microns, a bulk density of about 15 to 60 g/100 cc, and a melt index of about 0.5 to about 20 grams per 10 minutes.

22. The method of claim 14 wherein the average particle diameter is from about 400 microns to about 600 microns;
the bulk density is from about 20 to about 40 g/100 cc; and
the melt index is from about 0.5 to about 10 grams per 10 minutes.

23. The method of claim 14 wherein the plastic resin is a polyolefin-based resin, a polystyrene-based resin, a polycarbonate resin, or mixture thereof.

24. The method of claim 14 wherein the plastic resin is polyethylene or polypropylene.

25. A molded plastic part made by the process comprising:
a) charging a first mold half and a second mold half with a skin resin, wherein the first mold half and the second mold half are at a sufficient temperature to melt the skin resin;
b) allowing a first skin layer to form on the first mold half and a second skin layer to form on the second mold half;
c) inverting the first mold half and the second mold half such that excess skin resin is poured out;
d) optionally adding one or more reinforcements to the first skin layer and to the second skin layer;
e) charging the mold half and the second mold half with a foam resin;
f) clamping the first mold half and the second mold half together;
g) heating the first mold half and the second mold half to a sufficient temperature to activate the foam resin;
h) allowing a foam layer to form, wherein the foam layer is adhered to the first skin layer and to the second skin layer;
i) cooling the first mold half and the second mold half; and
j) removing the plastic part from the first mold half and the second mold half.

26. The molded plastic part of claim25 wherein the skin resin comprises:
a plastic resin; and
an antioxidant, wherein the skin resin is ground into a powder having an average particle diameter from about 95 microns to about 1300 microns, a bulk density of about 15 to 60 g/100 cc, and a melt index of about 0.5 to about 10 grams per 10 minutes.

27. The molded plastic part of claim 25, wherein:
the average particle diameter is from about 400 microns to about 600 microns;
the bulk density is from about 20 to about 40 g/100 cc; and
the melt index is from about 2 to 8 grams per 10 minutes.

28. The molded plastic part of claim 25 wherein the plastic resin is a polyolefin-based resin, a polystyrene-based resin, a polycarbonate resin, or mixture thereof.

29. The molded plastic part of claim 25 wherein the plastic resin is polyethylene or polypropylene.

30. The molded plastic part of claim 25 wherein the antioxidant is a phenol type antioxidant, phosphite type antioxidant, and thiol type antioxidant present in an amount of about 450 ppm to about 1750 ppm.

31. The molded plastic part of claim 25 wherein the skin resin further comprises a UV stabilizer.

32. The molded plastic part of claim 25 wherein the skin resin further comprises a flame retardant, a filler, a pigment additive, or mixtures thereof.

33. The molded plastic part of claim 25 wherein the foam resin comprises:
a plastic resin; and
a blowing agent present in an amount of about 1% to 12% of the total weight of the foam resin, wherein the skin resin wherein the skin resin is ground into a powder having an average particle diameter from about 95 microns to about 1300 microns, a bulk density of about 15 to 60 g/100 cc, and a melt index of about 0.5 to about 20 grams per 10 minutes.

34. The molded plastic part of claim 25 wherein
the average particle diameter is from about 400 microns to about 600 microns;
the bulk density is from about 20 to about 40 g/100 cc; and
the melt index is from about 0.5 to about 10 grams per 10 minutes.

35. The molded plastic part of claim 25 wherein the plastic resin is a polyolefin-based resin, a polystyrene-based resin, a polycarbonate resin, or mixture thereof.

36. The molded plastic part of claim 25 wherein the plastic resin is polyethylene or polypropylene.
